(19) United States
(12) Patent Application Publication
(10) Pub. No.: US 2004/0116003 A1
(43) Pub. Date: Jun. 17, 2004

(54) Electrical contact element

(76) Inventors: Jochen Wessner, Esslingen (DE); Werner Birkle, Ludwigsburg (DE); Piotr Deptula, Illingen (DE)

Correspondence Address: KENYON & KENYON, ONE BROADWAY, NEW YORK, NY, 10004, US

(21) Appl. No.: 10/467,050

(22) PCT Filed: Dec. 10, 2002
(86) PCT No.: PCT/DE02/04513

(30) Foreign Application Priority Data
Dec. 12, 2001 (DE) 101 60 871.3

(51) Int. Cl. H01R 11/22

(52) U.S. Cl. 439/856

(57) ABSTRACT

The present invention relates to an electrical contact element (1) for contacting a contact pin (4), the electrical contact element taking the form of a closed, planar, ring-shaped element; having at least one deformable, inwardly directed, retaining lip (2); and being made out of one piece.

The present invention relates to an electrical contact element.

In the electrical contacting of, in particular, relays and fuses in a motor vehicle, such as in fuse boxes, there is the problem of providing several electrical contacting points in a tight space, which must fulfill very strict requirements concerning the insertion and extraction forces to be achieved, as well as the contact resistances, while having a high degree of reproducibility and simultaneously reducing costs.

Up to now, a pressed screen made of conductive sheet metal has usually been used for electrically contacting relays and fuses in a motor vehicle, e.g. in a fuse box. In this connection, the contacts on the side of the pressed screen are either produced by a separately introduced contact (connection by soldering, welding to the conductor tracks) or by an insulation-displacement connection, in which the contact is bent out of the plane of the pressed screen.

As a rule, the tight spatial arrangement of the four to five relay contacts on a surface of approximately 22×18 mm, as well as their geometric boundary conditions (size, spring travel), do not allow the relay contacting to be realized in the plane of a pressed screen according to the procedure known up to this point.

Rather, one circumvents the problem of spatial limitation by making the pressed screen for each relay out of several separate parts and, above all, in several planes (multiple layers). The reason for this procedure is the boundary condition that, during the production of the pressed screen for a relay/fuse, the appropriate projection into a plane must be possible without instances of mutual contact or collisions.

The fact that a pressed screen must be made of several separate parts and, in particular, manufactured in several planes for contacting a relay represents a suboptimal design approach with respect to the required space, the degree of complexity, and the cost of the manufacturing process.

The object of the present invention is to provide an electrical contact element, in particular for electrically contacting relays and fuses in a motor vehicle, which satisfies the strict requirements for the insertion and extraction forces to be achieved, as well as for the contact resistances, while having a high degree of reproducibility and simultaneously reducing the number of separate parts to handle, while reducing the required space, especially with the aid of a single-layer, pressed screen, and while reducing the degree of complexity and the costs in the manufacturing process.

The object of the present invention is achieved by the electrical contact element defined in claim 1.

The idea forming the basis of the present invention is to generate suitable geometries of the device for the electrical contacting.

In the present invention, the problem mentioned at the outset is solved in that a ring-shaped, closed, planar device for electrical contacting has at least one deformable, inwardly directed, retaining lip and is made out of one piece.

Advantageous further refinements and improvements of the subject matter of the present invention are found in the dependent claims.

According to a preferred, further refinement, the device for electrical contacting, which may also be designated as, in particular, a pin holder, has exactly three inwardly directed, deformable, retaining lips.

According to a further preferred refinement, the retaining lip and/or the shank to which they are attached are essentially elastically deformable.

A further preferred refinement provides for the basic shape of the pin holder to be oval or hemispherical.

According to a further preferred refinement, the dimensions of the opening in the pin holder are markedly greater than the outer dimensions of a pin, in order to compensate for, in particular, tolerances in the dimensions of a pin and/or tolerances in the position of several pins with respect to each other.

A further preferred refinement provides for several or all pin holders to be situated in one plane to contact a unit having several pins, such as, in particular, a relay.

According to a further, preferred refinement, the electrical contacting is accomplished via the retaining lip(s) and/or the shanks to which they are attached, and/or the contacting has a specific, reproducible, contact resistance.

Exemplary embodiments of the present invention are represented in the drawings and explained in detail in the following description.

The figures show:

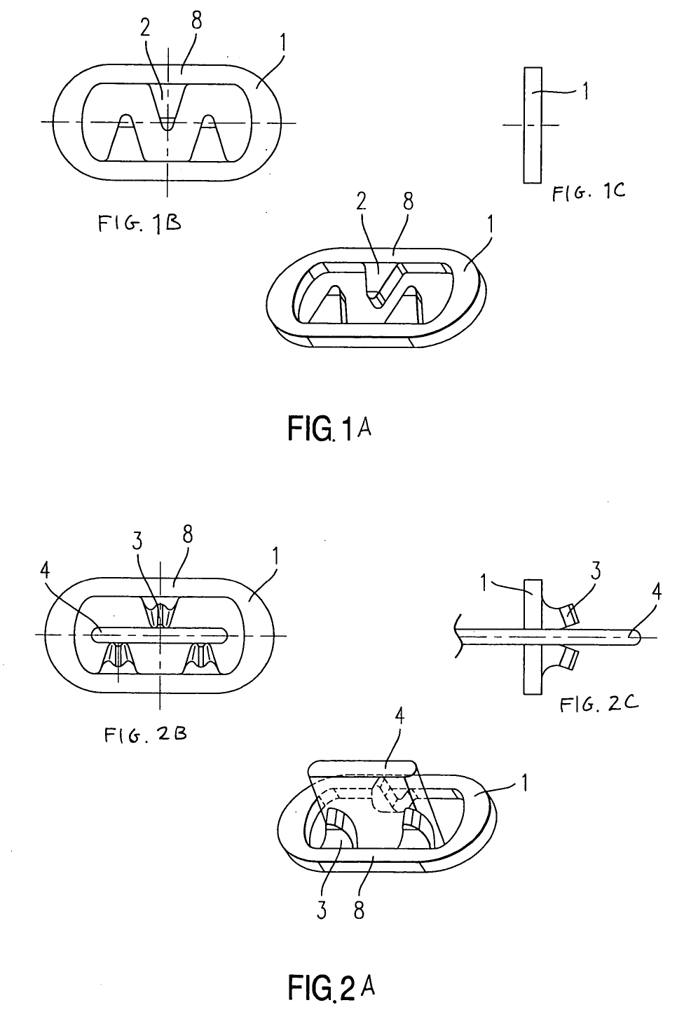

FIG. 1 a pin holder (basic oval shape) from three directions, having unbent retaining lips according to a first specific embodiment;

FIG. 2 a pin holder (basic oval shape) from three directions, having bent retaining lips (in the case of wedged contacting) according to a first specific embodiment;

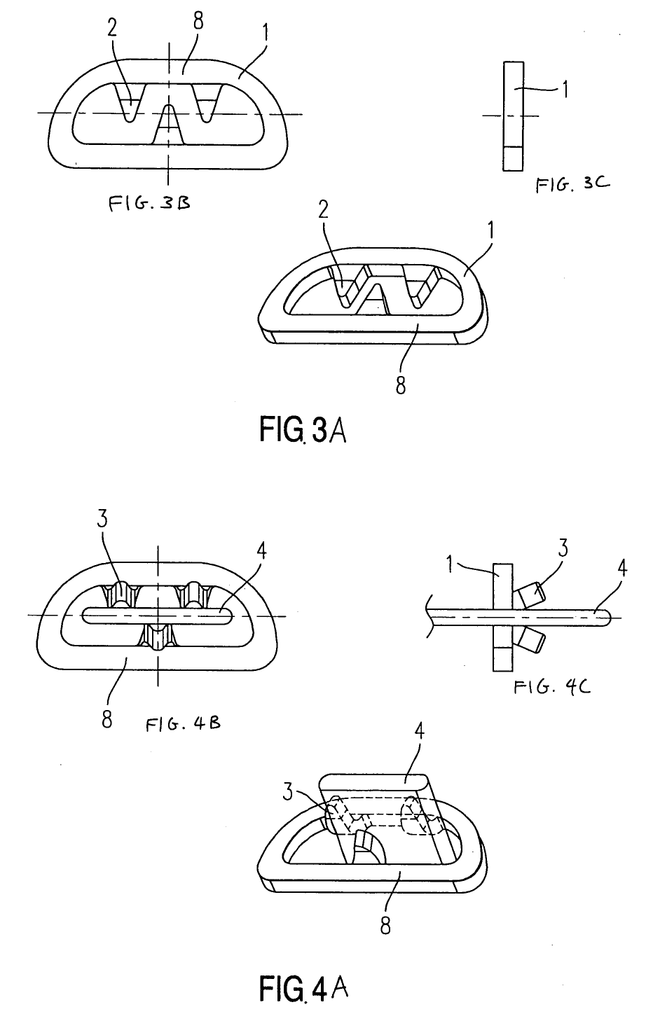

FIG. 3 a pin holder (basic hemispherical shape) from three directions, having unbent retaining lips according to a second specific embodiment;

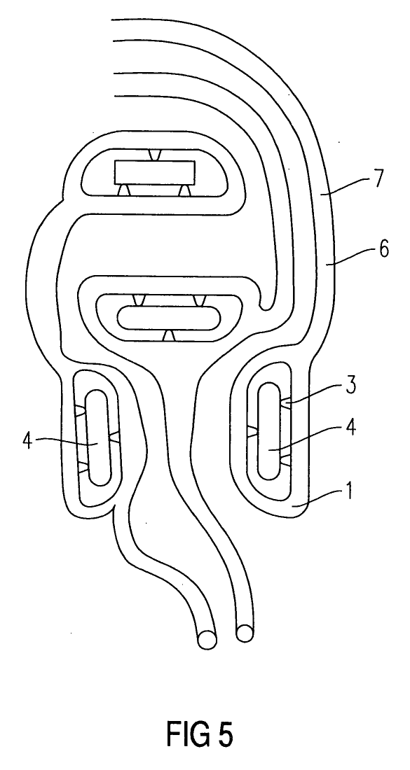

FIG. 4 a pin holder (basic hemispherical shape) from three directions, having bent retaining lips (in the case of wedged contacting) according to a second specific embodiment; and

FIG. 5 a schematic representation of a relay, having several pins contacted (from below) by the pin holder according to the second specific embodiment.

In the figures, the same reference characters denote identical and functionally identical components.

FIG. 1 shows a pin holder from three directions, as a first specific embodiment of the present invention.

Shown in FIG. 1 is a pin holder 1, whose basic shape is oval, and whose retaining lips 2 are directed inwardly in the unbent state. Pin holder 1 is a punched, planar, ring-shaped, sheet-metal part, the dimension of the opening being greater, in particular markedly greater, than that of pin 4 to be contacted. Pin holder 1 is connected to other electrical components in, e.g. a motor vehicle, via a conductor track 7 of, in particular, a pressed screen 6.

FIG. 2 shows pin holder 1 (basic oval shape) having bent retaining lips 3 in response to the insertion of pin 4. The insertion and retaining forces result from the pinching action between the three geometrically defined, bent retaining lips 3 having a corresponding insertion funnel (to compensate for tolerances). Retaining lips 3, which are essentially elastically deformable, form an insertion funnel in the bent state or in the process of inserting a pin 4. Pin 4 is electrically contacted in a reliable manner, and the contact resistance between pin 4 and pin holder 1 may be assigned a specific, reproducible value. The insertion and extraction forces during the insertion and extraction of pin 4 from pin holder 1 may also be assigned a specific, reproducible value. The insertion and retaining forces are a function of both the selected dimension of the gap between contact lips 2, 3 and the dimensions of pin 4 to be contacted.

FIG. 3 and FIG. 4 represent a further specific embodiment of the present invention, whereby the basic shape of pin holder 1 is, however, hemispherical, in order to receive, in particular, differently dimensioned pins 4.

FIG. 5 shows a schematic representation of the assembly of a pressed relay screen, which has several contacting points. For reasons of clarity, a plastic member, which supports pressed screen 6 and ensures the structural strength, in particular in the case of the fuse box, is not shown. The design of a pressed screen 6 for a relay 5 is selected in such manner, that tolerances in relay 5 (positional tolerances of pins 4) and inaccuracies in pressed screen 6 are compensated for by a desired mobility of the contact region assigned to each pin 4. This ensures that the results (insertion and retaining forces, contact resistances) are reproducible. A flexible (elastically deformable) connection of the contact regions allows tolerances in relay 5 and pressed screen 6 to be compensated for.

What is claimed is:

1. An electrical contact element (1) for contacting a contact pin (4), the electrical contact element
taking the form of a closed, planar, ring-shaped element;
having at least one deformable, inwardly directed, retaining lip (2); and
being made out of one piece.

2. The contact element as recited in claim 1,
wherein the contact element (1) has three deformable, inwardly directed, retaining lips (2).

3. The contact element as recited in claim 2,
wherein the contact element (1) has two retaining lips (2) on a long side (8) of the contact element and one retaining lip (2) centrally situated between the two retaining lips (2), on the opposite, long side (8) of the contact element.

4. The contact element as recited in one or more of the preceding claims,
wherein the retaining lips (2) are essentially elastically deformable.

5. The contact element as recited in one or more of the preceding claims,
wherein the basic shape of the contact element (1) is essentially oval.

6. The contact element as recited in one or more of the preceding claims,
wherein the basic shape of the contact element (1) is essentially hemispherical.

7. The contact element as recited in one or more of the preceding claims,
wherein the dimensions of the opening in the contact element (1) are markedly greater than the outer dimensions of the contact pin (4).

8. Use of a contact element as recited in one or more of the preceding claims,
wherein the electrical contacting is accomplished via the retaining lips (2) and/or the lateral, contact-region shanks (8) to which the retaining lips (2) are attached.

9. The contact element as recited in one or more of the preceding claims,
wherein the contact element (1) is a stamped part.

10. A set-up of several contact elements as recited in one or more of the preceding claims,
wherein, in order to contact a component having several contact pins (4), the contact elements (1) are positioned in one plane, in particular in the form of a pressed screen (6).

11. Use of a contact element as recited in one or more of the preceding claims, for contacting fuses and/or relays (5).

12. Use of a contact element as recited in one or more of the preceding claims, in a motor vehicle.

13. Use of a contact element as recited in one or more of the preceding claims, in an electrical-system control unit for a vehicle.
